(19) United States
(12) Patent Application Publication
(10) Pub. No.: US 2022/0206748 A1
(43) Pub. Date: Jun. 30, 2022

(54) Novel fast adder

(71) Applicant: Xinyu CHEN, Henan (CN)

(72) Inventor: Xinyu CHEN, Henan (CN)

(21) Appl. No.: 17/605,261

(22) PCT Filed: Apr. 22, 2020
(86) PCT No.: PCT/CN2020/086063

§ 371 Date: Oct. 21, 2021

(30) Foreign Application Priority Data
Apr. 23, 2019 (CN) 201910330150.1

(51) Int. Cl. G06F 7/503

(52) U.S. Cl. CPC G06F 7/503

(57) ABSTRACT

Disclosed is a novel fast adder, which belongs to the field of computer hardware processor design. By means of the novel fast adder, the number of gate circuit levels of a common adder can be reduced, such that the operating speed of a computer is increased. Two groups of recording modules are used for recording signals, and after the two groups of recording modules complete signal recording, a signal unit of one group of recording modules transfers the recorded signals to a signal-free unit of the other group of recording modules, and simplification of operation data is completed, and then a data addition operation is carried out, such that the operation time is shortened.

### FIELD OF THE INVENTION

The novel fast adder belongs to the data processing technology unit in the computer and plays an important role in the processor.

### BACKGROUND OF THE INVENTION

In recent years, computer technology has developed vigorously, the level of integration is getting higher and higher, and the level of technology is changing with each passing day. The components in a single processor have exploded and are approaching the physical limit. The present invention aims to design a more excellent addition unit on the same technological level and improve the speed of the computer.

### SUMMARY OF THE INVENTION

The technical problem to be solved by the present invention is to overcome the existing technical defects, optimize the input, and propose a faster adder with a new simple algorithm. The following is an example.

The adder proposed in the present invention performs fast summation of the input data, including:

The first recording module records at least two electrical level.

The second recording module records the same level as the number of digits recorded by the first recording module.

The first voltage comparator group includes voltage comparators with the same number of recording units in the first recording module.

The second voltage comparator group includes voltage comparators with the same number of recording units in the second recording module.

The charging circuit includes the same number of diodes as units of any recording modules. The addition circuit is composed of an AND circuit and a circuit breaker.

The controller controls the work of each part of the adder at the maximum speed according to the designed sequence.

### DETAILED DESCRIPTION OF THE EMBODIMENTS

The implementation steps of this example are carried out in an orderly manner under the control of the controller unit to use silicon tubes with a conduction voltage of 0.5 V, a power supply voltage of 1.0 V, and the output is assumed to have only eight bits.

In the first step, the first capacitor group records the binary number, and the high level 1.0 v is 1. The first capacitor group is shown in FIG. 1, including two or more capacitors. 8 capacitance bit examples.

In the second step, the second capacitor group records the binary number, and the high level 1.0 v is 1. The second capacitor group is shown in FIG. 2, including two or more capacitors. 8 capacitance bit examples.

The third step is to use a charging circuit to connect the corresponding capacitors in the first and second recording modules with the same subscript. The silicon diodes are biased to the second group. The charging circuit includes parallel diodes with the same number of capacitors in each recording module. Disconnect the charging circuit after charging. Take the charging circuit with 8 diodes as an example, as shown in FIG. 3.

Step 4 The first capacitor group is connected to the first voltage comparator group. One capacitor corresponds to one comparator. The high-level input outputs a high level to the first group of corresponding capacitors, which is less than the standard voltage 1.0 v and outputs a low level. The specific method is to connect the positive and negative poles of this capacitor, and disconnect it from the voltage comparator after the power is discharged. The number of voltage comparators is equal to the number of capacitors in each recording module. The following takes a unit as an example, as shown in FIG. 4. At the same time, the second capacitor module is connected to the second voltage comparator group, and the voltage is higher than 0.4 v as an example to output a high level, and the second capacitor module is recharged to make the level reach the standard state of the capacitor 1.0 v. Take a unit as an example below. As shown in FIG. 5.

The fifth step is to connect the first capacitor module and the second capacitor module with the addition circuit, and then disconnect it. The following is the addition circuit. Taking eight bits as an example, examples of the carry circuit that make up the addition circuit are given. The No. 8 capacitor carry circuit of the second capacitor module is shown in FIG. 6.

The No. 7 capacitor carry circuit of the second capacitor module is shown in FIG. 7.

The No. 6 capacitor carry circuit of the second capacitor module is shown in FIG. 8

The carry circuit of No. 5, No. 4, No. 3, and No. 2 of the second capacitor module can be deduced by analogy.

The addition circuit contains a circuit breaker. When a certain capacitance of the first recording module is at a high level, the circuit breaker circuit cuts off the AND gate formed by the capacitance of the second recording module corresponding to this capacitance and the capacitance lower than this capacitance. At the same time, the AND gate with more capacitance will cut off the AND gate circuit with less capacitance.

In the sixth step, the first voltage comparator group compares the capacitor voltage of the second group. The voltage comparator re-inputs 1.0 v when the capacitor voltage is 1.0 v, and drops the voltage to zero when the voltage is less than 1.0 v, and then Output or return to the first step to accumulate.

### BRIEF DESCRIPTION OF THE DRAWINGS

FIG. 1 shows the parallel arrangement of the same recording capacitors of the first recording module in an embodiment of the present invention.

FIG. 2 shows the parallel arrangement of the same recording capacitors of the second recording module in an embodiment of the present invention.

FIG. 3 shows that when a unit in the first recording module has a signal, but the unit in the corresponding second recording module has no signal, the electricity in the unit in the first recording module is partially transferred to the corresponding second recording module unit. This is the parallel diode used.

FIG. 4 shows a unit of the first voltage comparator group in an embodiment of the present invention.

FIG. 5 shows a unit of the second voltage comparator group in an embodiment of the present invention.

FIG. 6 shows a circuit for charging a capacitor labeled 8 in an embodiment of the present invention.

FIG. 7 shows a circuit for charging a capacitor labeled 7 in an embodiment of the present invention.

FIG. 8 shows a circuit for charging a capacitor labeled 6 in an embodiment of the present invention.

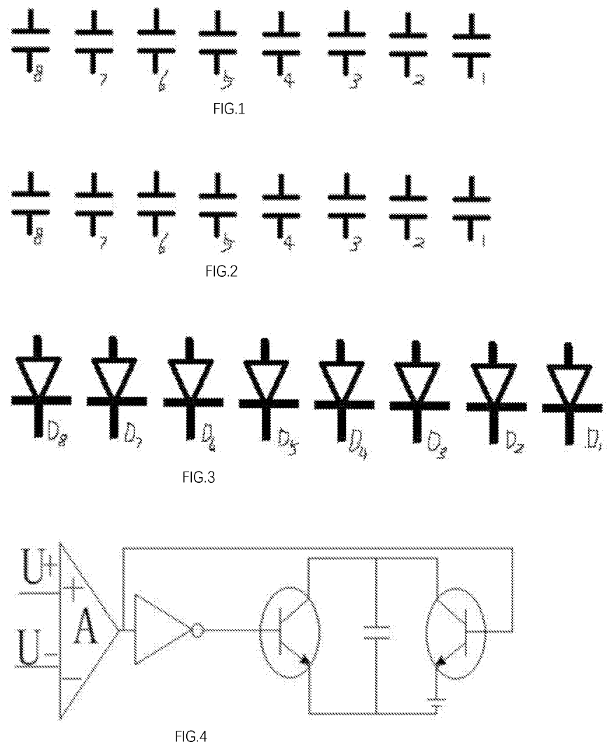

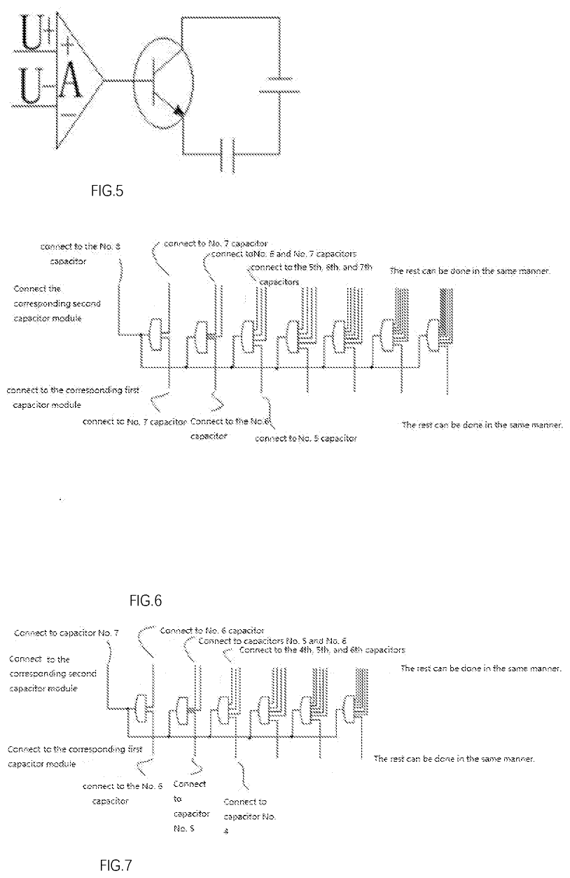

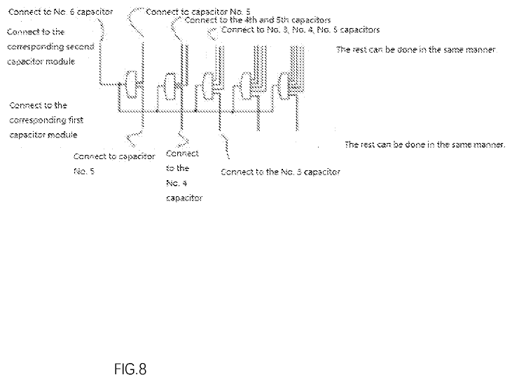

It should be pointed out that the specification only provides technical implementation cases and does not limit the claims. Anyone skilled in the art can equivalently replace or modify part or all of the technology of the present invention after reading it, or even partially merge it. The technical spirit of the present invention should fall within the scope of the claims.

What is claimed is:

1. A new type of novel fast adder, which is characterized in that: the signal units with signal in the first recording module transfer the signal to the corresponding non-signal units of the second recording module in a certain way after the signal units finish recording the signal, and then connect to the carry circuit. The carry circuit summarizes all carry possibilities, the carry signal is recorded in the second recording module, and all units signal participating in the carry that have not been carried are changed to zero and the result is finally output

2. The novel fast adder of claim 1, wherein the complete transfer of the signal from the first recording module to the second recording module requires a voltage comparator to complete subsequent work.

3. The novel fast adder according to claim 1, characterized in that: when the adding circuit is connected, the combination of the units with signal in the first recording module and the units with signal in the second recording module with the same relative subscript activates the circuit breaker Circuit, so that the low-order carry circuit is disconnected here.

4. The novel fast adder according to claim 1, characterized in that: when the adding circuit is connected, if the circuit in the carry circuit containing more signal units is turned on, the circuit breaker circuit will be activated and the corresponding carry circuit containing fewer signal units will be turned off.
